(19) United States
(12) Patent Application Publication
(10) Pub. No.: US 2013/0324399 A1
(43) Pub. Date: Dec. 5, 2013

(54) FUNGICIDAL COMPOSITIONS AND METHODS OF USE

(71) Applicants: Jennifer Riggs, Raleigh, NC (US); Danise Beadle, Cantonment, FL (US); Katharine Vuocolo, Raleigh, NC (US)

(72) Inventors: Jennifer Riggs, Raleigh, NC (US); Danise Beadle, Cantonment, FL (US); Katharine Vuocolo, Raleigh, NC (US)

(73) Assignee: Bayer Cropscience LP, Research Triangle Park, NC (US)

(21) Appl. No.: 13/816,875

(22) PCT Filed: Aug. 9, 2011
(86) PCT No.: PCT/US11/47048

§ 371 Date: Aug. 22, 2013

Related U.S. Application Data
(60) Provisional application No. 61/386,141, filed on Sep. 24, 2010.

(51) Int. Cl. A01N 43/16; A01N 63/00; A01N 37/22

(52) U.S. Cl. CPC A01N 43/16; A01N 37/22; A01N 63/00
USPC 504/100; 514/538; 514/33; 424/93.4

(57) ABSTRACT

Compositions and methods for protecting plants from fungal, bacterial, and viral diseases are provided, which compositions comprise at least one compound that produces systemic acquired resistance and at least one antifungal compound. Compositions of the disclosure may be applied directly to seeds, seedlings, shoots, roots, and/or foliage of the plant to be protected, thereby protecting them from the fungal, bacterial, and viral diseases.

### BACKGROUND

1. Field

The present compositions and methods are broadly concerned with methods and compositions for protecting plants from fungal diseases, damping-off, aerial blights, rots, leaf spots, and other conditions. More particularly, the compositions comprise at least one compound that produces systemic acquired resistance, such as at least one saponin, and at least one antifungal compound. These compositions may be applied directly to seeds, seedlings, shoots, roots, and/or foliage of the plant to be protected. These compositions may also be applied directly to seeds, seedlings, shoots, roots, and/or foliage of a plant that is infected with a disease, thereby treating the disease. In addition to fungal diseases, the compositions are useful for protecting and treating the plants against bacterial and viral diseases including, but not limited to, fire blight, Goss's and Stewart's Wilt, soft rots, general bacterial spots and wilts, cucumber mosaic virus, barley yellow dwarf virus and tomato spotted wilt virus.

2. Description of Related Art

There are numerous plant diseases caused by pathogenic microorganisms (e.g., bacteria, viruses, or fungi), which may infect plants at various stages of development from seeds to full-grown plants. Generally, protection of plants from such diseases relies upon application of agents that are toxic to the pathogenic microbe (e.g., insecticides, nematicides, fungicides, bactericides, etc.). Depending on the site of infection or attack, the toxic agents, such as pesticides, are applied via several routes, including seed treatments, soil drenches, and foliar sprays. Conventional pesticides, however, work through direct contact with the pathogen or they are absorbed by the plant and fulfill their function when plant tissues are consumed (systemic pesticides).

Seedling damping-off, brown root rot, or Pythium root rot are predominantly seedling diseases, causing reduced stands, delayed maturity and yield reductions. Pythium, for example, is most frequent where soil oxygen levels are low due to high rainfall. In western Canada, for example, disease develops in wet soils low in phosphorus and organic matter. Spores of Pythium survive for many years in soil and crop residue. The worst outbreaks with the heaviest damage occur when a dry spell is followed by abundant rain. Damping off occurs frequently when germination takes place under wet conditions. Seedlings that emerge usually recover but may experience impaired root development and delayed maturity. Disease symptoms appear in patches throughout fields, especially in waterlogged areas. Infected plants become chlorotic, and lower leaves turn yellow, then brown. Underground, one may find dead root tips on small plants and brown lesions on roots of larger plants, particularly at tips of young roots.

Cool wet conditions can lead to seedling blights. They are caused by many different pathogens, including Penicillium spp., Pythium spp., Fusarium spp., Rhizoctonia spp., Phytophthora spp., Thielaviopsis spp., Phellinus spp., and others. Fields more conducive to cool wet conditions (no till) are more susceptible to seedling blights caused by such pathogens. Also, low lying areas of fields that stay wet longer can be more at risk. Seedling blights occur pre- and post-emergence—in either case, plants are either weakened or die prematurely. Fungicidal seed treatments ensure that even in poor conditions, seed is allowed to germinate and emerge without the serious issues that can take place when seed is unprotected.

Pesticides used as seed treatments are dried onto seeds, where the pesticides interfere directly with soil-borne pathogens or pests that attack the seeds, seedlings, or roots. Pesticides may also be applied to roots (e.g., as a dip), or to foliage (e.g., as a spray). Such protection is usually temporary, and declines as the treatment degrades, or is diluted. Known pesticides are also toxic to non-target species, reducing biodiversity and even harming beneficial species such as pollinating or predatory insects.

Over time, target pests and pathogens may develop resistance to pesticidal compositions, thus requiring escalating amounts of pesticide to achieve the intended effect, but risking even more harm to beneficial species. Because of this problem, attempts have been made to replace pesticidal application with compositions which stimulate the plant's own defense genes to cause the plant to produce proteins which inhibit disease. These products produce what is commonly known as a systemic acquired resistance (SAR) response within the plant. See, e.g., Gurr S J, et al. “Engineering plants with increased disease resistance: how are we going to express it?” Trends Biotechnol. 2005; 23(6):283-290 and Sheen J, et al. “Sugars as signaling molecules” Curr Opin Plant Biol. 1999; 2(5):410-418.

Plants respond to a wide variety of environmental stimuli, and responses include those that provide protection against pests (e.g., insects) and pathogens (e.g., fungi, bacteria, and viruses). Plant responses to pest or pathogen attack are brought about by a chain of events that link the initial recognition of the stimulus to changes in cells of the plant that ultimately lead to protection. Thus, in response to wounding and to pest/pathogen challenge, there are local and systemic events induced, with signal transduction pathways occurring at the local site, systemic signals communicating the local events throughout the plant, and signal transduction pathways occurring in distant cells that respond to the systemic signals. Several compounds obtained from plants (e.g., salicylic acid, jasmonic acid, etc.) have been implicated in the development of SAR, but such compounds are generally expensive, may damage plants, and the protection afforded is limited. One such plant is Chenopodium quinoa. As a pesticide active ingredient, saponins extracted from Chenopodium quinoa plants are applied pre-planting to seeds of food crops such as beans and cereals, and to tomato seedlings before transplant. This treatment is intended to prevent the seeds and tomato plants from developing diseases caused by fungi, as well as by certain bacteria and viruses. See, e.g., U.S. Pat. No. 6,743,752; U.S. 2003/0162731; and U.S. 2005/0261129.

Therefore, there remains a need for an economical method for stimulating a plant's own immune system to combat plant pathogens, preferably employing a naturally-obtained composition in order to lessen potential environmental concerns.

There also remains a need for effective compositions and methods that use environmentally friendly biological components and less toxic chemical fungicides, utilizing them in such a manner that they provide improved plant vigor and yield without the use of more toxic traditional chemical fungicides.

The technical problem was therefore to overcome these prior art difficulties by providing a cost-effective, environmentally friendly composition for effectively treating and/or preventing diseases in plants. The solution to this technical problem is provided by the embodiments characterized in the claims.

### BRIEF SUMMARY

In an embodiment, the present disclosure provides a composition comprising at least one fungicide and at least one compound that produces systemic acquired resistance. In one aspect, the at least one fungicide is mixed with the at least one compound that produces systemic acquired resistance. In one aspect, the at least one fungicide is physically separate from the at least one compound that produces systemic acquired resistance. In one aspect, the at least one fungicide comprises at least one xylylalanine. In one aspect the at least one xylylalanine is selected from the group consisting of benalaxyl, furalaxyl, mefenoxam, metalaxyl, L-metalaxyl, and combinations thereof. In one aspect, the at least one compound that produces systemic acquired resistance is at least one saponin. In one aspect, the at least one saponin is obtained from Chenopodium quinoa. In one aspect, the at least one saponin comprises oleanolic acid. In one aspect, the at least one saponin comprises hederagenin. In one aspect, the at least one saponin comprises phytolaccagenic acid. In one aspect, the at least one saponin comprises quillaic acid. In one aspect, the at least one saponin is selected from oleanolic acid, hederagenin, phytolaccagenic acid, quillaic acid, and combinations thereof. In one aspect, the at least one saponin comprises approximately equimolar amounts of the triterpene bidesmosidic glycosides of oleanolic acid, hederagenin, and phytolaccagenic acid. In one aspect, the at least one saponin comprises approximately equimolar amounts of oleanolic acid, hederagenin, phytolaccagenic acid, and quillaic acid. In one aspect, the composition further comprises at least one insecticide and/or at least one spore-forming bacterium, and/or at least one nematicide. In one aspect, the at least one fungicide, at least one compound that produces systemic acquired resistance, optional at least one insecticide, optional at least one spore-forming bacterium, and optional at least one nematicide are applied separately to the seed, plant, or plant part; in another aspect they are combined in any combination thereof and applied together to the seed, plant, or plant part.

In an embodiment, the present disclosure provides a method of protecting a seed or plant from disease, and a method for treating a seed or plant infected with disease, the methods comprising the step of applying at least one fungicide and at least one compound that produces systemic acquired resistance to said seed or plant. In one aspect, the at least one fungicide and at least one compound that produces systemic acquired resistance to said seed or plant are applied separately. In one aspect, the at least one fungicide and at least one compound that produces systemic acquired resistance to said seed or plant are mixed and are applied together. In one aspect, the at least one fungicide is a xylylalanine. In one aspect, the xylylalanine is selected from the group consisting of benalaxyl, furalaxyl, mefenoxam, metalaxyl, L-metalaxyl, and combinations thereof. In one aspect, the at least one compound that produces systemic acquired resistance is at least one saponin. In one aspect, the said at least one saponin is obtained from Chenopodium quinoa. In one aspect, the said at least one saponin comprises oleanolic acid. In one aspect, the at least one saponin comprises hederagenin. In one aspect, the at least one saponin comprises phytolaccagenic acid. In one aspect, the at least one saponin comprises quillaic acid. In one aspect, the at least one saponin is selected from oleanolic acid, hederagenin, phytolaccagenic acid, quillaic acid, and combinations thereof. In one aspect, the at least one saponin comprises approximately equimolar amounts of the triterpene bidesmosidic glycosides of oleanolic acid, hederagenin, and phytolaccagenic acid. In one aspect, the at least one saponin comprises approximately equimolar amounts of the triterpene bidesmosidic glycosides of oleanolic acid, hederagenin, phytolaccagenic acid, and quillaic acid. In one aspect, the composition further comprises at least one insecticide and/or at least one spore-forming bacterium, and/or at least one nematicide. In one aspect, the at least one fungicide, at least one compound that produces systemic acquired resistance, optional at least one insecticide, optional at least one spore-forming bacterium, and optional at least one nematicide are applied separately to the seed, plant, or plant part; in another aspect they are combined in any combination thereof and applied together to the seed, plant, or plant part.

In an embodiment, the present disclosure provides a seed having an outer surface and a composition on at least a portion of the surface comprising at least one fungicide and at least one compound that produces systemic acquired resistance. In one aspect the at least one fungicide and at least one compound that produces systemic acquired resistance to said seed or plant are applied to the seed separately. In one aspect, the at least one fungicide and at least one compound that produces systemic acquired resistance to said seed or plant are mixed and applied to the seed together. In one aspect, the at least one fungicide is a xylylalanine. In one aspect, the xylylalanine is selected from the group consisting of benalaxyl, furalaxyl, mefenoxam, metalaxyl, L-metalaxyl, and combinations thereof. In one aspect, the at least one compound that produces systemic acquired resistance is at least one saponin. In one aspect, the at least one saponin is obtained from Chenopodium quinoa. In one aspect, the at least one saponin comprises the triterpene bidesmosidic glycoside of oleanolic acid. In one aspect, the at least one saponin comprises the triterpene bidesmosidic glycoside of hederagenin. In one aspect, the at least one saponin comprises the triterpene bidesmosidic glycoside of phytolaccagenic acid. In one aspect, the at least one saponin comprises quillaic acid. In one aspect, the at least one saponin is selected from oleanolic acid, hederagenin, phytolaccagenic acid, quillaic acid, and combinations thereof. In one aspect, the at least one saponin comprises approximately equimolar amounts of the triterpene bidesmosidic glycosides of oleanolic acid, hederagenin, and phytolaccagenic acid. In one aspect, the at least one saponin comprises approximately equimolar amounts of the triterpene bidesmosidic glycosides of oleanolic acid, hederagenin, phytolaccagenic acid, and quillaic acid. In one aspect, the outer surface and composition further comprises an insecticide and/or at least one spore-forming bacterium, and/or at least one nematicide. In one aspect, the at least one fungicide, at least one compound that produces systemic acquired resistance, optional at least one insecticide, optional at least one spore-forming bacterium, and optional at least one nematicide are applied separately to the seed, plant, or plant part; in another aspect they are combined in any combination thereof and applied together to the seed, plant, or plant part.

In an embodiment, the present disclosure provides a method of reducing or preventing the spread of fungicide resistance in fungi, the method comprising the step of applying to a seed or a plant at least one fungicide and at least one compound that produces systemic acquired resistance. In one aspect the at least one fungicide and at least one compound that produces systemic acquired resistance to said seed or plant are applied to the seed or plant separately. In one aspect, the at least one fungicide and at least one compound that produces systemic acquired resistance to said seed or plant are mixed and applied to the seed or plant together. In one aspect, the xylylalanine is selected from the group consisting of benalaxyl, furalaxyl, mefenoxam, metalaxyl, L-metalaxyl, and combinations thereof. In one aspect, the at least one compound that produces systemic acquired resistance is at least one saponin. In one aspect, the at least one saponin is obtained from Chenopodium quinoa. In one aspect, the at least one saponin comprises oleanolic acid. In one aspect, the at least one saponin comprises hederagenin. In one aspect, the at least one saponin comprises phytolaccagenic acid. In one aspect, the at least one saponin comprises quillaic acid. In one aspect, the at least one saponin is selected from oleanolic acid, hederagenin, phytolaccagenic acid, quillaic acid, and combinations thereof. In one aspect, the at least one saponin comprises approximately equimolar amounts of the triterpene bidesmosidic glycosides of oleanolic acid, hederagenin, and phytolaccagenic acid. In one aspect, the at least one saponin comprises approximately equimolar amounts of the triterpene bidesmosidic glycosides of oleanolic acid, hederagenin, phytolaccagenic acid, and quillaic acid. In one aspect, the outer surface and composition further comprises an insecticide and/or at least one spore-forming bacterium, and/or at least one nematicide. In one aspect, the at least one fungicide, at least one compound that produces systemic acquired resistance, optional at least one insecticide, optional at least one spore-forming bacterium, and optional at least one nematicide are applied separately to the seed, plant, or plant part; in another aspect they are combined in any combination thereof and applied together to the seed, plant, or plant part.

Other compositions and methods in accordance with the composition are provided in the detailed description and claims that follow below. Additional objects, features, and advantages will be sent forth in the description that follows, and in part, will be obvious from the description, or may be learned by practice of the compositions and methods. The objects, features, and advantages may be realized and obtained by means of the instrumentalities and combination particularly pointed out in the appended claims.

### BRIEF DESCRIPTION OF THE DRAWINGS

For a further understanding of the nature, objects, and advantages of the present composition and methods, reference should be had to the following detailed description, read in conjunction with the following drawings, wherein like reference numerals denote like elements.

FIGS. 1A and 1B provide graphical representations of the data of TABLE 1.

FIG. 2 provides a graphical representation of the data of TABLE 2.

FIG. 3 provides a graphical representation of the data of TABLE 3.

FIGS. 4A and 4B provide graphical representations of the data of TABLE 4, wherein FIG. 4A shows the data from Variety A, and FIG. 4B shows the data from Variety B.

FIGS. 5A and 5B provide graphical representations of the data of TABLE 5, wherein FIG. 5A shows the data from Variety A, and FIG. 5B shows the data from Variety B.

### DETAILED DESCRIPTION

Before the subject compositions and methods are further described, it is to be understood that the compositions and methods are not limited to the particular embodiments of the compositions and methods described below, as variations of the particular embodiments may be made and still fall within the scope of the appended claims. It is also to be understood that the terminology employed is for the purpose of describing particular embodiments, and is not intended to be limiting. Instead, the scope of the present compositions and methods will be established by the appended claims.

In this specification and the appended claims, the singular forms “a,” “an,” and “the” include plural reference unless the context clearly dictates otherwise. Unless defined otherwise, all technical and scientific terms used herein have the same meaning as commonly understood to one of ordinary skill in the art to which these compositions and methods belong.

The instant compositions and methods address or overcome the problems of the prior art by broadly providing effective compositions and methods for treating and/or protecting plants from diseases.

As used herein, “plant” is intended to refer to any part of a plant (e.g., roots, foliage, shoot) as well as trees, shrubbery, flowers, and grasses. “Seed” is intended to include seeds, tubers, tuber pieces, bulbs, and the like, or parts thereof from which a plant is grown.

Provided herein are improved compositions and methods for controlling microbial (e.g., bacterial, viral, or fungal) damage or infestations in plants and seeds. With some combinations of the invention, the degree of control over microbial damage or infestation is unexpectedly significantly greater than would be expected from the sum of the composition components alone (e.g., synergy is observed). Consequently, the amount of composition required to control said microbial damage or infestation in plants is significantly less than would be expected from the sum of the composition components alone. This finding dramatically improves the cost-benefit ratio while lowering the chances that microbial resistance will develop. Also, when treating seeds the space available to apply any composition is limited because seeds are relatively small. Thus, reducing the amount (volume) of composition required to achieve control of microbial damage or infestation—without compromising efficacy—represents a significant advance.

The compositions provided for controlling damage or infestations in plants comprise (a) at least one fungicide, and (b) at least one compound that produces systemic acquired resistance in an (a)/(b) weight ratio of from about 0.01 to about 50, from about 1 to about 40, from about 5 to about 30, from about 5 to about 25, and preferably from about 8 to about 16. The individual components or composition can be applied to the seed, the plant, the plant foliar, to the fruit of the plant, or the soil wherein the plant is growing or wherein it is desired to grow. The individual components (a) and (b) may be applied separately as separate components at different times, they may be applied separately as separate components at the same time, or they may be mixed or formulated together before application and so applied together (i.e., simultaneously).

Fungicidal ingredients (a) suitable for the composition of the present disclosure include aldimorph, ampropylfos, ampropylfos potassium, andoprim, anilazine, azaconazole, azoxystrobin, benalaxyl, benodanil, benomyl, benzamacril, benzamacryl-isobutyl, bialaphos, binapacryl, biphenyl, bitertanol, blasticidin-S, boscalid, bromuconazole, bupirimate, buthiobate, calcium polysulfide, capsimycin, captafol, captan, carbendazim, carboxin, carvon, quinomethionate, chlobenthiazone, chlorfenazole, chloroneb, chloropicrin, chlorothalonil, chlozolinate, clozylacon, cufraneb, cymoxanil, cyproconazole, cyprodinil, cyprofuram, debacarb, dichlorophen, diclobutrazole, diclofluanid, diclomezine, dicloran, diethofencarb, difenoconazole, dimethirimol, dimethomorph, dimoxystrobin, diniconazole, diniconazole-M, dinocap, diphenylamine, dipyrithione, ditalimfos, dithianon, dodemorph, dodine, drazoxolon, edifenphos, epoxiconazole, etaconazole, ethirimol, etridiazole, famoxadon, fenapanil, fenarimol, fenbuconazole, fenfuram, fenitropan, fenpiclonil, fenpropidin, fenpropimorph, fentin acetate, fentin hydroxide, ferbam, ferimzone, fluazinam, fludioxonil, flumetover, fluopyram, fluoromide, fluquinconazole, flurprimidol, flusilazole, flusulfamide, flutolanil, flutriafol, folpet, fosetyl-aluminium, fosetyl-sodium, fthalide, fuberidazole, furalaxyl, furametpyr, furcarbonil, furconazole, furconazole-cis, furmecyclox, guazatine, hexachlorobenzene, hexaconazole, hymexazole, imazalil, imibenconazole, iminoctadine, iminoctadine albesilate, iminoctadine triacetate, iodocarb, ipconazole, iprobenfos (IBP), ipconazole, iprodione, irumamycin, isoprothiolane, isovaledione, kasugamycin, kresoxim-methyl, copper preparations, such as: copper hydroxide, copper naphthenate, copper oxychloride, copper sulfate, copper oxide, oxine-copper and Bordeaux mixture, mancopper, mancozeb, maneb, mefenoxam, meferimzone, mepanipyrim, mepronil, metalaxyl, L-metalaxyl, metconazole, methasulfocarb, methfuroxam, metiram, metomeclam, metsulfovax, mildiomycin, myclobutanil, myclozolin, nickel dimethyldithiocarbamate, nitrothal-isopropyl, nuarimol, ofurace, oxadixyl, oxamocarb, oxolinic acid, oxycarboxim, oxyfenthiin, paclobutrazole, pefurazoate, penconazole, pencycuron, penflufen, phosdiphen, pimaricin, piperalin, polyoxin, polyoxorim, probenazole, prochloraz, procymidone, propamocarb, propanosine-sodium, propiconazole, propineb, prothiocinazole, pyraclostrobin, pyrazophos, pyrifenox, pyrimethanil, pyroquilon, pyroxyfur, quinconazole, quintozene (PCNB), sulfur and sulfur preparations, tebuconazole, tecloftalam, tecnazene, tetcyclasis, tetraconazole, thiabendazole, thicyofen, thifluzamide, thiophanate-methyl, thiram, tioxymid, tolclofos-methyl, tolylfluanid, triadimefon, triadimenol, triazbutil, triazoxide, trichlamide, tricyclazole, tridemorph, trifloxystrobin, triflumizole, triforine, triticonazole, uniconazole, validamycin A, vinclozolin, viniconazole, xylylalanines, zarilamide, zineb, ziram and also Dagger G, OK-8705, OK-8801, α-(1,1-dimethylethyl)-β-(2-phenoxyethyl)-1H-1,2,4-triazole-1-ethanol, α-(2,4-dichlorophenyl)-β-fluoro-β-propyl-1H-1,2,4-triazole-1-ethanol, α-(2,4-dichlorophenyl)-β-methoxy-α-methyl-1H-1,2,4-triazole-1-ethanol, α-(5-methyl-1,3-dioxan-5-yl)-β-[[4-(trifluoromethyl)-phenyl]-methylene]-1H-1,2,4-triazole-1-ethanol, (5RS,6RS)-6-hydroxy-2,2,7,7-tetramethyl-5-(1H-1,2,4-triazol-1-yl)-3-octanone, (E)-α-(methoxyimino)-N-methyl-2-phenoxy-phenylacetamide, 1-isopropyl{2-methyl-1-[[[1-(4-methylphenyl)-ethyl]-amino]-carbonyl]-propyl}carbamate, 1-(2,4-dichlorophenyl)-2-(1H-1,2,4-triazol-1-yl)-ethanone-O-(phenylmethyl)-oxime, 1-(2-methyl-1-naphthalenyl)-1H-pyrrole-2,5-dione, 1-(3,5-dichlorophenyl)-3-(2-propenyl)-2,5-pyrrolidindione, 1-[(diiodomethyl)-sulfonyl]-4-methyl-benzene, 1-[[2-(2,4-dichlorophenyl)-1,3-dioxolan-2-yl]-methyl]-1H-imidazole, 1-[[2-(4-chlorophenyl)-3-phenyloxiranyl]-methyl]-1H-1,2,4-triazole, 1-[1-[2-[(2,4-dichlorophenyl)-methoxy]-phenyl]-ethenyl]-1H-imidazole, 1-methyl-5-nonyl-2-(phenylmethyl)-3-pyrrolidinole, 2′,6′-dibromo-2-methyl-4′-trifluoromethoxy-4′-trifluoro-methyl-1,3-thiazole-5-carboxanilide, 2,2-dichloro-N-[1-(4-chlorophenyl)-ethyl]-1-ethyl-3-methyl-cyclopropanecarboxamide, 2,6-dichloro-5-(methylthio)-4-pyrimidinyl-thiocyanate, 2,6-dichloro-N-(4-trifluoromethylbenzyl)-benzamide, 2,6-dichloro-N-[[R4-(trifluoromethyl)-phenyl]-methyl]-benzamide, 2-(2,3,3-triiodo-2-propenyl)-2H-tetrazole, 2-[(1-methylethyl)-sulfonyl]-5-(trichloromethyl)-1,3,4-thiadiazole, 2-[[6-deoxy-4-O-(4-O-methyl-β-D-glycopyranosyl)-α-D-glucopyranosyl]-amino]-4-methoxy-1H-pyrrolo[2,3-d]pyrimidine-5-carbonitrile, 2-aminobutane, 2-bromo-2-(bromomethyl)-pentanedinitrile, 2-chloro-N-(2,3-dihydro-1,1,3-trimethyl-1H-inden-4-yl)-3-pyridinecarboxamide, 2-chloro-N-(2,6-dimethylphenyl)-N-(isothiocyanatomethyl)-acetamide, 2-phenylphenol (OPP), 3,4-dichloro-1-[4-(difluoromethoxy)-phenyl]-1H-pyrrole-2,5-dione, 3,5-dichloro-N-[cyano[(1-methyl-2-propynyl)-oxy]-methyl]-benzamide, 3-(1,1-dimethylpropyl-1-oxo-1H-indene-2-carbonitrile, 3-[2-(4-chlorophenyl)-5-ethoxy-3-isoxazolidinyl]-pyridine, 4-chloro-2-cyano-N,N-dimethyl-5-(4-methylphenyl)-1H-imidazole-1-sulfonamide, 4-methyl-tetrazolo[1,5-a]quinazolin-5(4H)-one, 8-(1,1-dimethylethyl)-N-ethyl-N-propyl-1,4-dioxaspiro[4,5]decane-2-methanamine, 8-hydroxyquinoline sulfate, 9H-xanthene-2-[(phenylamino)-carbonyl]-9-carboxylic hydrazide, bis-(1-methylethyl)-3-methyl-4-[(3-methylbenzoyl)-oxy]-2,5-thiophenedicarboxylate, cis-1-(4-chlorophenyl)-2-(1H-1,2,4-triazol-1-yl)-cycloheptanol, cis-4-[3-[4-(1,1-dimethylpropyl)-phenyl-2-methylpropyl]-2,6-dimethyl-morpholine hydrochloride, ethyl[(4-chlorophenyl)-azo]-cyanoacetate, potassium bicarbonate, methanetetrathiol-sodium salt, methyl 1-(2,3-dihydro-2,2-dimethyl-1H-inden-1-yl)-1H-imidazole-5-carboxylate, methyl N-(2,6-dimethylphenyl)-N-(5-isoxazolylcarbonyl)-DL-alaninate, methyl N-(chloroacetyl)-N-(2,6-dimethylphenyl)-DL-alaninate, N-(2,3-dichloro-4-hydroxyphenyl)-1-methyl-cyclohexanecarboxamide, N-(2,6-dimethylphenyl)-2-methoxy-N-(tetrahydro-2-oxo-3-furanyl)-acetamide, N-(2,6-dimethylphenyl)-2-methoxy-N-(tetrahydro-2-oxo-3-thienyl)-acetamide, N-(2-chloro-4-nitrophenyl)-4-methyl-3-nitro-benzenesulfonamide, N-(4-cyclohexylphenyl)-1,4,5,6-tetrahydro-2-pyrimidinamine, N-(4-hexylphenyl)-1,4,5,6-tetrahydro-2-pyrimidinamine, N-(5-chloro-2-methylphenyl)-2-methoxy-N-(2-oxo-3-oxazolidinyl)-acetamide, N-(6-methoxy)-3-pyridinyl)-cyclopropanecarboxamide, N-[2,2,2-trichloro-1-[(chloroacetyl)-amino]-ethyl]-benzamide, N-[3-chloro-4,5-bis(2-propinyloxy)-phenyl]-N′-methoxy-methanimidamide, N-formyl-N-hydroxy-DL-alanine-sodium salt, O,O-diethyl[2-(dipropylamino)-2-oxoethyl]-ethylphosphoramidothioate, O-methyl S-phenyl phenylpropylphosphoramidothioate, S-methyl 1,2,3-benzothiadiazole-7-carbothioate, and spiro[2H]-1-benzopyrane-2,1′(3′H)-isobenzofuran]-3′-one, alone or in combination.

Preferably, the fungicide component (a) comprises at least one xylylalanine. Preferably, the xylylalanine is selected from the group consisting of benalaxyl, furalaxyl, mefenoxam, metalaxyl, and L-metalaxyl. More preferably, the xylylalanine is metalaxyl and/or L-metalaxyl.

Compounds (b) that produce systemic acquired resistance and are suitable for the composition of the present disclosure include salicylic acid, silicon, phosphate, 2-thiouracil, polyacrylic acid, nucleic acids, fosethyl-AI, jasmonic acid, benzothiadiazole, polygalacturonase inhibitor proteins, 2,6-dichloroisonicotinic acid and its methyl ester, benzo(1,2,3)thiadiazole-7-carbothioic acid S-methyl ester, and saponins.

Preferably, the at least one compound (b) that produces systemic acquired resistance is at least one saponin. The at least one saponin may comprise oleanolic acid (b1), hederagenin (b2), phytolaccagenic acid (b3), and/or quillaic acid (b4) in an amount of (b1):(b2):(b3):(b4) weight ratio of from about 1:0.01:0.01:0.01:0.00 to about 1:100:100:100, from about 1:0.1:0.1:0.1:0.0 to about 1:50:50:50, and from about 1:1:1:0 to about 1:1:1:1; the ratios of compounds (b1), (b2), (b3), and (b4) varying independently from each other. Preferably, the at least one saponin may be approximately equimolar amounts of oleanolic acid, hederagenin, and phytolaccagenic acid. The at least one saponin may also be approximately equimolar amounts of oleanolic acid, hederagenin, phytolaccagenic acid, and quillaic acid.

While any saponin is suitable for use in the compositions, the saponin should preferably be obtained from a plant different than the plant that the final saponin composition is intended to protect. Suitable sources of saponins include Quinoa (Chenopodium quinoa), Chenopodiaceae, Quillaja (Quillajaceae, e.g., Quillaja saponica), Primrose (Primula spp.), Senega (Polygala senega), Gypsophila spp., Horse chestnuts (Aesculus spp.), Ginseng (Panax spp. and Eleutherocosus spp.), Licorice (Glycyrrhiza spp.), Ivy (Hedera spp.), Tea seed (Camellia sinensis), Alfalfa (Medicago sativa), Soya (Glycine max), Yucca (Yucca spp.), and Dioscoreaceae. It is particularly preferred that the saponin be of the triterpene variety as found in Quinoa and Quillaja, versus the steroidal types found in Yucca.

Quinoa is classified as a member of the Chenopodiaceae, a large and varied family which includes cultivated spinach and sugar beet. Quinoa is an extremely hardy and drought-resistant plant which can be grown under harsh ecological conditions—high altitudes, relatively poor soils, low rainfall, and cold temperatures—that other major cereal grains, such as corn and wheat, cannot tolerate.

Quinoa originated in the Andes region of South America where it was a staple grain in pre-Spanish Conquest times. Traditional uses of quinoa declined after the Spanish Conquest. Cultivation and use of the grain was not widespread until a recent revival due to Western interest in this crop as a high lysine, high protein grain for human consumption. The principal obstacle to even wider human consumption of quinoa has been, and continues to be, the bitter taste of the saponin present in the grain.

Chemically, saponins include a range of related compounds. They are a type of sterol glycoside widely distributed in diverse plant species, including Chenopodium quinoa, they possess detergent-like properties, and they help plants resist microbial pathogens such as fungi, viruses, and bacteria. The major saponin constituents in the extract of C. quinoa seeds include primarily approximately equimolar amounts of the triterpene bidesmosidic glycosides of oleanolic acid, hederagenin, and phytolaccagenic acid. Chenopodium quinoa seeds have a long history of use in South America as a dietary supplement, and are marketed in the U.S. as the cereal product “Quinoa.” Based on toxicity studies and the presence of these saponins in many food products, this active ingredient is not expected to harm humans, other non-target organisms, or the environment. There are generally two types of saponin—triterpene saponins and steroidal saponins. Traditionally, saponin has been removed by washing the grain in running water, although new methods have been developed recently (see, e.g., WO 99/53933).

Saponins of Chenopodium quinoa are a cream beige powder with a meaty odor characteristic of finely ground proteinaceous material. The saponins may be extracted from quinoa by various methods, including by placing a saponin-containing portion of a quinoa plant in an aqueous alcohol (e.g., methanol, ethanol) solution to form a saponin-containing solution and an extracted, solid residue. The alcohol is then removed from the solution followed by evaporation of the water to yield the saponin-containing composition (containing saponins of approximately equimolar amounts of the triterpene bidesmosidic glycosides of oleanolic acid, hederagenin, and phytolaccagenic acid). Those skilled in the art will appreciate that the saponins can also be extracted from quinoa by other methods for use with the instant compositions and methods (see, e.g., U.S. Pat. No. 6,482,770, which is incorporated by reference herein in its entirety) and can be modified (e.g., by hydrolysis).

In one aspect, a composition intended for use as a seed treatment is provided. In another aspect, a composition intended for use as a pre-plant root dip is provided. In another aspect, a composition intended for use as a foliar treatment is provided. In another aspect, a composition intended to be used prior to transplant is provided. In another aspect, a composition intended to be used after transplant is provided. In some aspects, the composition is a powder, a liquid, a coating, an aerosol, or a solid.

In some aspects, a composition comprising: (a) at least one fungicide; (b) at least one compound that produces systemic acquired resistance; and a seed is provided.

In the treatment of plants, the total concentrations of the disclosed compositions can be varied within a relatively wide range. In general, they are between about 0.01 and about 99.9, about 0.1% and about 99%, about 0.5 and about 90%, about 10% and about 75%, and preferably about 15% and about 70% by weight of the combination of at least one fungicide (a) and at least one compound that produces systemic acquired resistance (b), with the remaining weight comprising additional components described below.

In the treatment of seed, the amounts of the at least one fungicide and at least one compound that produces systemic acquired resistance can be varied within a relatively wide range. In general, they are from about 0.001 to about 50 grams, from about 0.01 to about 30 grams, from about 0.1 to about 15.6 grams, from about 1.6 to about 15.6 grams, and preferably from about 1.6 to about 10.6 grams of the combination of at least one fungicide (a) and at least one compound that produces systemic acquired resistance (b) per 100 Kg of seed.

The composition of the present disclosure may further comprise additional components such as nematicides, insecticides, bacteria, binders, stabilizers, emulsifiers, solvents, or carriers, depending on the properties desired, which may comprise between about 1% and about 99.9%, about 5% and about 75%, about 5% and about 50%, and about 10% and about 25% by weight of the composition.

Suitable nematicides include antibiotic nematicides such as abamectin; carbamate nematicides such as benomyl, carbofuran, carbosulfan, and cleothocard; oxime carbamate nematicides such as alanycarb, aldicarb, aldoxycarb, oxamyl; organophosphorous nematicides such as diamidafos, fenamiphos, fosthietan, phosphamidon, cadusafos, chlorpyrifos, diclofenthion, dimethoate, ethoprophos, fensulfothion, fostiazate, heterophos, isamidofos, isazofos, methomyl, phorate, phosphocarb, terbufos, thiodicarb, thionazin, triazophos, imicyafos, and mecarphon. Other suitable nematicides include acetoprole, benclothiaz, chloropicrin, dazomet, DBCP, DCIP, 1,2-dichloropropane, 1,3-dichloropropene, fluopyram, furfural, iodomethane, metam, methyl bromide, methyl isothiocyanate, and xylenols. Suitable biological nematicides include Myrothecium verrucaria, Burholderia cepacia, Bacillus chitonosporus, Bacillus firmus, Pasteuria usage, and Paecilomyces lilacinus or nematicides of plant or animal origin such as harpin proteins, amino acid sequences or virus, viroid particles. The preferred nematicides are: thiodicarb, abamectin, harpin protein, Bacillus firmus, and Pasteuria usage. In general, they are from about 0.001 to about 1000 grams, from about 0.01 to about 500 grams, from about 0.1 to about 300 grams, from about 1.6 to about 100 grams, and preferably from about 1.6 to about 100 grams of the combination of at least one nematicide (a) and at least one compound that produces systemic acquired resistance (b) per 100 Kg of seed.

Suitable insecticides include non-nematicidal, neonicotinoid insecticides such as 1-(6-chloro-3-pyridylmethyl)-N-nitroimidazolidin-2-ylideneamine (imidacloprid), 3-(6-chloro-3-pyridylmethyl)-1,3-thiazolidin-2-ylidenecyanamide (thiacloprid), 1-(2-chloro-1,3-thiazol-5-ylmethyl)-3-methyl-2-nitroguanidine (clothianidin), nitempyran, N¹-[(6-chloro-3-pyridyl)methyl]-N²-cyano-N¹-methylacetamidine (acetamiprid), 3-(2-chloro-1,3-thiazol-5-ylmethyl)-5-methyl-1,3,5-oxadiazinan-4-ylidene(nitro)amine (thiamethoxam) and 1-methyl-2-nitro-3-(tetrahydro-3-furylmethyl)guanidine (dinotefuran). The preferred insecticides are: clothianidin, imidacloprid, and thiamethoxam. In general, they are from about 0.001 to about 1000 grams, from about 0.01 to about 500 grams, from about 0.1 to about 300 grams, from about 1.6 to about 100 grams, and preferably from about 1.6 to about 100 grams of the combination of at least one nematicide (a) and at least one compound that produces systemic acquired resistance (b) per 100 Kg of seed.

Suitable bacteria are those that are able to provide protection from the harmful effects of plant pathogenic fungi or bacteria and/or soil-borne parasites such as nematodes or other helminths. Protection against plant parasitic nematodes and parasitic microorganisms can occur through chitinolytic, proteolytic, collagenolytic, or other activities detrimental to these soil borne animals and/or detrimental to microbial populations. Bacteria exhibiting these nematicidal, fungicidal and bactericidal properties may include but are not limited to, Bacillus argri, Bacillus aizawai, Bacillus albolactis, Bacillus amyloliquefaciens, Bacillus cereus, Bacillus coagulans, Bacillus endoparasiticus, Bacillus endorhythmos, Bacillus firmus, Bacillus kurstaki, Bacillus lacticola, Bacillus lactimorbus, Bacillus lactis, Bacillus laterosporus, Bacillus lentimorbus, Bacillus licheniformis, Bacillus megaterium, Bacillus medusa, Bacillus metiens, Bacillus natto, Bacillus nigrificans, Bacillus popillae, Bacillus pumilus, Bacillus siamensis, Bacillus sphearicus, Bacillus spp., Bacillus subtilis, Bacillus thurngiensis, Bacillus unifagellatus, plus those listed in the category of Bacillus Genus in Bergey's Manual of Systematic Bacteriology, First Ed. (1986), hereby incorporated by reference in its entirety. In one embodiment, spore-forming bacteria or root colonizing bacteria are used to protect the seed. Examples of suitable bacteria include B. firmus CNCM I-1582 spore, B. cereus strain CNCM I-1562 spore both of which are disclosed in U.S. Pat. No. 6,406,690, hereby incorporated by reference in its entirety. Other spore-forming bacteria include B. amyloliquefaciens IN937a, B. subtillis strain designated GB03, and B. pumulis strain designated GB34. Further, the spore-forming bacteria can be a mixture of any species listed above, as well as other spore-forming, root colonizing bacteria known to exhibit agriculturally beneficial properties. The preferred bacteria are: Bacillus subtillus, Bacillus amyloliquefaciens, Bacillus firmus, and Bacillus pumulis. In general, they are from about 0.001 to about 100 grams, from about 0.01 to about 50 grams, from about 0.1 to about 30 grams, from about 1.6 to about 10 grams, and preferably from about 1.6 to about 10 grams of the combination of at least one nematicide (a) and at least one compound that produces systemic acquired resistance (b) per 100 Kg of seed.

Binders can be added to the composition of the present disclosure, and include those composed of an adhesive polymer that can be natural or synthetic, without phytotoxic effect on the seed to be coated. A variety of colorants may be employed, including, but not limited to, organic chromophores classified as nitroso, nitro, azo, including monoazo, bisazo, and polyazo, diphenylmethane, triarylmethane, xanthene, methane, acridine, thiazole, thiazine, indamine, indophenol, azine, oxazine, anthraquinone, and phthalocyanine, inorganic pigments, iron oxide, titanium oxide and Prussian Blue, and organic dyestuffs, such as alizarin dyestuffs, azo dyestuffs and metal phthalocyanine dyestuffs. Other additives that can be added include trace nutrients such as salts of iron, manganese, boron, copper, cobalt, molybdenum, and zinc. A polymer or other dust control agent can be applied to retain the treatment on the seed surface, including, but not limited to, cellulose-base, starch-base, silicone-base, polypropylene, polyvinylchloride, polycarbonate, polystyrene, polybutadiene, vinyl-based and styrene butadiene.

Other conventional seed treatment additives include, but are not limited to, coating agents, wetting agents, buffering agents, and polysaccharides. At least one agriculturally acceptable carrier can be added to the seed treatment formulation such as water, solids or dry powders. The dry powders can be obtained from a variety of materials such as wood barks, calcium carbonate, gypsum, vermiculite, talc, humus, activated charcoal, and various phosphorous compounds.

Optionally, stabilizers and buffers can be added, including alkaline and alkaline earth metal salts and organic acids, such as citric acid and ascorbic acid, inorganic acids, such as hydrochloric acid or sulfuring acid. Biocides can also be added and can included formaldehydes or formaldehyde-releasing agents and derivatives of benzoic acid, such as p-hydroxybenzoic acid. Further additives include functional agents capable of protecting seeds from harmful effects of selective herbicides such as activated carbon, nutrients (fertilizers), and other agents capable of improving the germination and quality of the compositions or a combination thereof.

The components of the seed composition can be converted into the customary formulations, such as aerosol dispenser, capsule suspension, cold fogging concentrate, dustable powder, emulsifiable concentrate, emulsion oil in water, emulsion water in oil, encapsulated granule, fine granule, flowable concentrate for seed treatment, gas (under pressure), gas generating product, granule, hot fogging concentrate, macrogranule, microgranule, natural and synthetic materials impregnated with active compound, oil dispersible powder, oil miscible flowable concentrate, oil miscible liquid, paste, plant rodlet, powder, powder for dry seed treatment, seed coated with a pesticide, soluble concentrate, soluble powder, solution for plant treatment, solution for seed treatment, suspensions, suspension concentrate (flowable concentrate), ultrafine encapsulations in polymeric materials, ultra low volume (ulv) liquid, ultra low volume (ulv) suspension, suspoemulsion concentrates, water dispersible granules or tablets, water dispersible powder for slurry treatment, water soluble granules or tablets, water soluble powder for seed treatment and wettable powder. These formulations are produced in the known manner, for example by mixing the active compound with extenders, that is, liquid solvents and/or solid carriers, optionally with the use of surfactants, (e.g., emulsifiers, dispersants, foaming agents, wetting agents of ionic or non-ionic type, or mixtures thereof). Suitable emulsifiers and/or foam formers are, for example, non-ionic and anionic emulsifiers, such as polyoxyethylene fatty acid esters, polyoxyethylene fatty alcohol ethers, for example alkylaryl polyglycol ethers, alkylsulfonates, alkyl sulfates, arylsulfonates as well as protein hydrolysates; suitable dispersants are, for example, lignin-sulfite waste liquors and methylcellulose. The surfactant content may comprise between about 0.1% and about 40%, about 5% and about 40%, about 10% and about 40%, about 20% and about 40%, about 30% and about 40%, about 0.1% and about 30%, about 0.1% and about 20%, about 0.1% and about 10%, and about 0.1% and about 5% by weight of the composition.

These compositions include not only compositions which are ready to be applied to the plant or seed to be treated by means of a suitable device, such as a spraying or dusting device, but also concentrated commercial compositions which must be diluted before they are applied to the plant or seed.

Suitable extenders are, for example, water, polar and nonpolar organic chemical liquids, for example from the classes of the aromatic and nonaromatic hydrocarbons (such as paraffins, alkylbenzenes, alkylnaphthalenes, chlorobenzenes), of the alcohols and polyols (which can optionally also be substituted, etherified and/or esterified), of the ketones (such as acetone, cyclohexanone), esters (including fats and oils) and (poly)ethers, of the unsubstituted and substituted amines, amides, lactams (such as N-alkylpyrrolidones) and lactones, the sulfones and sulfoxides (such as dimethyl sulfoxide).

In the case of the use of water as an extender, organic solvents can, for example, also be used as cosolvents. Liquid solvents which are suitable include mainly: aromatics, such as xylene, toluene or alkylnaphthalenes, chlorinated aromatics or chlorinated aliphatic hydrocarbons, such as chlorobenzenes, chloroethylenes or methylene chloride, aliphatic hydrocarbons, such as cyclohexane or paraffins, for example mineral oil fractions, mineral oils and vegetable oils, alcohols, such as butanol or glycol as well as their ethers and esters, ketones, such as acetone, methyl ethyl ketone, methyl isobutyl ketone or cyclohexanone, strongly polar solvents, such as dimethylformamide and dimethyl sulfoxide, and water.

The term “carrier” denotes a natural or synthetic, organic or inorganic material with which the active materials are combined to make them easier to apply, notably to the parts of a plant. This carrier is thus generally inert and should be agriculturally acceptable. The carrier may be a solid or a liquid. Examples of suitable carriers include clays, natural or synthetic silicates, silica, resins, waxes, solid fertilizers, water, alcohols, in particular butanol, organic solvents, mineral and plant oils and derivatives thereof. Mixtures of such carriers may also be used. Solid carriers which are suitable for use in the composition of the invention include, for example, ammonium salts and ground natural minerals, such as kaolins, clays, talc, chalk, quartz, attapulgite (palygorskite), montmorillonite or diatomaceous earth, and ground synthetic minerals, such as highly-disperse silica, alumina and silicates; suitable solid carriers for granules are: for example crushed and fractionated natural rocks such as calcite, marble, pumice, sepiolite and dolomite, and synthetic granules of inorganic and organic meals, and granules of organic material such as sawdust, coconut shells, maize cobs and tobacco stalks.

Additives such as carboxymethylcellulose and natural and synthetic polymers in the form of powders, granules or lattices, such as gum arabic, polyvinyl alcohol and polyvinyl acetate, and natural phospholipids, such as cephalins and lecithins, and synthetic phospholipids, can also be used in the composition formulations.

Methods for treating a seed, plant and/or plant part with the composition are also provided. In one embodiment, the method comprises: (a) providing a composition comprising an effective amount of at least one compound that produces systemic acquired resistance; (b) combining the compound that produces systemic acquired resistance with at least one fungicide to create a composition; (c) applying the composition to the seed, plant, and/or plant part; and (d) optionally repeating step (c).

In one embodiment, the method comprises: (a) providing a composition comprising at least one fungicide; (b) providing a composition comprising an effective amount of at least one compound that produces systemic acquired resistance; (c) applying the composition of (a) to the seed, plant, and/or plant part; and (d) applying the composition of (b) to the seed, plant, and/or plant part. In one aspect, the compositions of (a) and (b) are applied simultaneously. In one aspect the compositions of (a) and (b) are applied separately. In one aspect, steps (c) and (d) are repeated, independently of each other, at least once.

The seed, plant and/or plant part may be treated with the compositions of this disclosure by applying the compositions directly to the seed, plant and/or plant part. In another embodiment, the seed, plant and/or plant part may be treated indirectly, for example by treating the environment or habitat in which the seed, plant and/or plant part are or will be exposed to. Conventional treatment methods may be used to treat the seed, plant and/or plant part, environment, or habitat including dipping, dusting, spraying, fumigating, fogging, scattering, brushing on, injecting, and, in the case of propagation material, in particular seeds, furthermore by coating with one or more coats.

The application steps can be done in any desired manner, such as in the form of seed coating, soil drench, root dip, and/or directly in-furrow and/or as a foliar spray and applied either pre-emergence, post-emergence or both. When the composition comprising at least one fungicide (a) and the composition comprising an effective amount of at least one compound that produces systemic acquired resistance (b) are separate compositions, the application steps may be performed in any order, and in any combination of applications, such as alternating applications of (a) and (b), multiple applications of (a) and one application of (b), and the like. Without being bound by theory, it is believed that the at least one fungicide acts in synergy with the at least one saponin, thereby resulting in the superior effects observed.

In another embodiment, said application is made: 1) before the seeds are planted; 2) to roots at transplanting of seedlings; 3) to foliage before transplanting seedlings; or 4) to foliage after transplanting seedlings. In another embodiment, said application is made inside a greenhouse, outside of a greenhouse, or outside within a portable spray chamber.

In a further embodiment, a method of protecting a seed, plant, or plant part from fungi is provided, comprising providing at least one composition comprising at least one compound that produces systemic acquired resistance, such as a saponin, and at least one antifungal agent; and applying the composition to the seed, plant, or plant part.

In one aspect, a method of manufacturing a seed treated with at least one compound that produces systemic acquired resistance and an antifungal agent is provided, comprising: (a) applying said at least one compound that produces systemic acquired resistance and said at least one antifungal agent to said seed; and (b) mixing said seed to achieve a substantially uniform treatment. In a further aspect, the at least one compound that produces systemic acquired resistance and the at least one antifungal agent are mixed together before they are applied to the seed. In a further aspect, the at least one compound that produces systemic acquired resistance and the at least one antifungal agent are applied to the seed separately. In a further aspect, the number of applications of the at least one compound that produces systemic acquired resistance and the at least one antifungal agent vary independently of one another.

If the composition of the present disclosure is in powder form, the at least one compound that produces systemic acquired resistance and the at least one fungicide may be applied directly to the seed separately or mixed together and then applied to the seed. If the components are in liquid form, they may be sprayed or atomized onto the seed or in-furrow at the time of planting, either separately or mixed together.

The seeds are substantially uniformly coated with one or more layers of the composition of the present disclosure using conventional methods of mixing, spraying or a combination thereof. Application is generally done using specifically designed and manufactured equipment that accurately, safely, and efficiently applies seed treatment compositions to seeds. Such equipment uses various types of coating technology such as rotary coaters, drum coaters, fluidized bed techniques, spouted beds, rotary mists or a combination thereof. In one embodiment, application is done via either a spinning “atomizer” disk or a spray nozzle which evenly distributes the seed treatment onto the seed as it moves through the spray pattern. The seed may then be mixed or tumbled for an additional period of time to achieve additional treatment distribution and drying. The seeds can be primed or unprimed before coating with the compositions to increase the uniformity of germination and emergence. In an alternative embodiment, a dry powder composition can be metered onto the moving seed.

The seeds may be coated via a continuous or batch coating process. In a continuous coating process, continuous flow equipment simultaneously meters both the seed flow and the seed treatment compositions. A slide gate, cone and orifice, seed wheel, or weight device (belt or diverter) regulates seed flow. Once the seed flow rate through treating equipment is determined, the flow rate of the seed treatment is calibrated to the seed flow rate in order to deliver the desired dose to the seed as it flows through the seed treating equipment. Additionally, a computer system may monitor the seed input to the coating machine, thereby maintaining a constant flow of the appropriate amount of seed. In a batch coating process, batch treating equipment weighs out a prescribed amount of seed and places the seed into a closed treating chamber or bowl where the corresponding of seed treatment is then applied. The seed and seed treatment are then mixed to achieve a substantially uniform coating on each seed. This batch is then dumped out of the treating chamber in preparation for the treatment of the next batch. With computer control systems, this batch process is automated enabling it to continuously repeat the batch treating process. In either coating process, the seed coating machinery can optionally be operated by a programmable logic controller that allows various pieces of equipment to be started and stopped without employee intervention. The components of this system are commercially available through several sources, such as Gustafson Equipment of Shakopee, Minn.

In one embodiment, the composition of the present disclosure is formulated as a soil treatment. The soil treatment may be in addition or, or as a substitute for, the seed treatment. Soil may be treated by application of the desired composition to the soil by conventional methods such as spraying. Alternatively, the desired composition can be introduced to the soil before germination of the seed or directly to the soil in contact with the roots by utilizing a variety of techniques included, but not limited to, drip irrigation, sprinklers, soil injection or soil drenching. The desired composition may be applied to the soil before planting, at the time of planting, or after planting the seed.

The fungi treatable by methods and compositions described herein include, but are not limited to members of the class Oomycetes, Pythium spp., Phytophthora spp., Fusarium spp., Rhizoctonia spp., Penicillium spp., Aspergillus spp., Alternaria spp., Cladosporium spp., Helminthosporium spp., and Bipolaris spp.

The methods and compositions disclosed reduce damage caused by the fungi by about 10%, about 20%, about 30%, about 40%, about 50%, about 60%, about 70%, about 80%, about 90%, or about 100%, based on comparisons of damage between seeds and/or plants that were treated with compositions of the instant disclosure, and those that were not so treated.

All seeds, plants and plant parts can be treated in accordance with the compositions and methods described herein, including, but not limited to beets (including, but not limited to, garden beets and sugar beets), bird's foot trefoil, cereals (including, but not limited to, wheat, barley, rye, oats, millet, milo, corn, buckwheat, rice, and triticale), corn (including, but not limited to, field corn, sweet corn, and popcorn), cotton, cucumbers, dry beans, flax, forage grasses (including, but not limited to, grasses grown for hay, grazing, or silage, corn fodder, corn silage, sorghum hay, and sorghum silage), fruit plants (including, but not limited to, apples, pears citrus fruits, and grapes), legumes (including, but not limited to, alfalfa, clover, lespedeza, beans, soybeans, soybean hay, peanuts, peanut hay, peas, pea vine hay, cowpeas, cowpea hay, trefoil, vetch, and velvet beans), lettuce, oilseed rape (including, but not limited to, canola), peas, potatoes, rice, sainfoin, seed and pod vegetables (including, but not limited to, black-eyed peas, chickpeas, cowpeas, dill, edible soybeans, field beans, field peas, garden peas, green beans, kidney beans, lima beans, lupines, navy beans, okra, peas, pinto beans, pole beans, snap beans, string beans, wax beans, and lentils), sorghum, sunflowers, swiss chard, tobacco, tomato, tubers, and turf grasses. In this context, plants are understood as meaning all plants and plant populations such as desired and undesired wild plants or crop plants (including naturally occurring crop plants). Crop plants can be plants which can be obtained by traditional breeding and optimization methods or by biotechnological and recombinant methods, or combinations of these methods, including the transgenic plants and including the plant varieties which are capable or not capable of being protected by Plant Breeders' Rights. Plant parts are understood as meaning all aerial and subterranean parts and organs of the plants such as shoot, leaf, flower and root, examples which may be mentioned being leaves, needles, stalks, stems, flowers, fruit bodies, fruits and seeds, but also roots, tubers and rhizomes. The plant parts also include crop material and vegetative and generative propagation material, for example cuttings, tubers, rhizomes, slips, and seeds.

In one embodiment, plant species and plant varieties which are found in the wild or which are obtained by traditional biological breeding methods, such as hybridization or protoplast fusion, and parts of these species and varieties are treated. In a further embodiment, transgenic plants and plant varieties which were obtained by recombinant methods, if appropriate in combination with traditional methods (genetically modified organisms) and their parts are treated. The terms “parts”, “parts of plants” or “plant parts” are described above.

Plants which can be treated include those of the varieties which are commercially available or in use. Plant varieties are understood as meaning plants with novel traits which have been bred both by conventional breeding, by mutagenesis or by recombinant DNA techniques. They may take the form of varieties, biotypes or genotypes. The transgenic plants or plant varieties (plants or plant varieties obtained by means of genetic engineering) which can be treated include all plants which, by means of the recombinant modification, have received genetic material which confers particularly advantageous valuable traits to these plants. Examples of such traits are better plant growth, increased tolerance to high or low temperatures, increased tolerance to drought or to water or soil salinity, increased flowering performance, facilitated harvest, speedier maturation, higher yields, higher quality and/or higher nutritional value of the crop products, better storability and/or processability of the crop products. Other examples of such traits which are particularly emphasized are improved defense of the plants against animal and microbial pests such as insects, mites, phytopathogenic fungi, bacteria and/or viruses, and an increased tolerance of the plants to specific herbicidal active compounds.

Examples of transgenic plants which are mentioned are the important crop plants such as cereals (including, but not limited to, wheat, rice barley, rye, oats, millet, milo, corn, buckwheat, and triticale), maize, soybeans, potato, cotton, tobacco, oilseed rape and fruit plants (with the fruits apples, pears, citrus fruits and grapes), with particular emphasis on maize, soybeans, potatoes, cotton, tobacco and oilseed rape (e.g., canola). Without intending to be limited thereby, other examples of transgenic crops which may benefit from the compositions and processes disclosed herein include alfalfa, barley, bird's foot trefoil, canola, clover, cucumber, dry beans, fall rye, field corn, flax, legumes, lettuce, LibertyLink corn hybrids, oats, peas, sainfoin, seed and pod vegetables, sunflowers, swiss chard, vetch, and wheat. Transgenic traits which are particularly emphasized are the increased defense of the plants against insects, arachnids, nematodes and slugs and snails as the result of toxins formed in the plants, in particular toxins which are produced in the plants by the genetic material of Bacillus thuringiensis (for example by the genes CryIA(a), CryIA(b), CryIA(c), CryIIA, CryIIIA, CryIIIB2, Cry9c, Cry2Ab, Cry3Bb and CryIF and their combinations) (hereinbelow “Bt plants”). Traits which are also particularly emphasized are the increased defence of plants against fungi, bacteria and viruses by systemic acquired resistance (SAR), systemin, phytoalexins, elicitors and resistance genes and correspondingly expressed proteins and toxins. Traits which are furthermore especially emphasized are the increased tolerance of the plants to specific herbicidal active compounds, for example imidazolinones, sulphonylureas, glyphosate or phosphinothricin (for example “PAT” gene). The specific genes which confer the desired traits can also occur in combinations with one another in the transgenic plants.

Examples of “Bt plants” include maize varieties, cotton varieties, soybean varieties and potato varieties sold under the trade names YIELD GARD (for example maize, cotton, soybean), KNOCKOUT (for example maize), STARLINK (for example maize), BOLLGARD (cotton), NUCOTN (cotton) and NEWLEAF (potato). Examples of herbicide-tolerant plants which may be mentioned are maize varieties, cotton varieties and soybean varieties which are sold under the trade names ROUNDUP READY (glyphosate tolerance, for example maize, cotton, soybean), LIBERTY LINK (phosphinothricin tolerance, for example oilseed rape), IMI (imidazolinone tolerance) and STS (sulphonylurea tolerance, for example maize). Herbicide-resistant plants (bred conventionally for herbicide tolerance) which may also be mentioned are the varieties sold under the name CLEARFIELD (for example maize). Naturally, what has been said also applies to plant varieties which will be developed, or marketed, in the future and which have these genetic traits or traits to be developed in the future.

The following examples serve to illustrate certain aspects of the disclosure and are not necessarily intended to limit the disclosure.

### Example 1

Example 1 shows the advantages achieved by applying the combination of at least one saponin with at least one fungicide to corn. As shown in TABLE 1, corn seeds infected with Pythium were exposed to various treatment regimens, and then allowed to grow in a field. Unlike other experiments disclosed herein, the soil for the experiment of EXAMPLE 1 was not inoculated with Pythium. Uninfected untreated, and Pythium-infected untreated seeds served as controls. Triadimenol, 15% w/v, is a systemic broad-spectrum fungicide used for cereal seed treatment, but has no activity against Pythium spp. Metalaxyl, 28.35% w/v, provides systemic protection for the seed, roots, and emerging plants against Pythium, systemic downy mildew, and Phytophthora. For corn, the industry standard dosage of metalaxyl is 2 grams of active ingredient per 100 kilograms of seed (2 GA/100 Kg). Saponin, 49.65% v/v extract of Chenopodium quinoa saponins, contained approximately equimolar amounts of triterpene bidesmosidic glycosides of oleanolic acid, hederagenin, and phytolaccagenic acid. Unexpectedly, and as shown in TABLE 1, the combination of saponin with half of the industry-standard dosage of metalaxyl yielded results comparable to those seen with metalaxyl alone at either the industry-standard dosage or at twice the industry-standard dosage (see TABLE 1). In TABLE 1, “Vigor” represents a subjective measure of plant health and is based on uniformity, consistent plant mass, and consistent plant spacing, with lower scores being more favorable than higher scores.

TABLE 1
Corn

| | | 30 DAA | | | 46 DAA | | | |
|---|---|---|---|---|---|---|---|---|
| Pythium | Treatment | | | Relative | | | Relative | |
| (+/−) | (GA/100 Kg) | Count | Density | Density | Count | Density | Density | Vigor |
| − | — | 27 | 33.8 | 90 | 47 | 58.1 | 75.3 | 4.75 |
| + | — | 30 | 37.5 | 100 | 62 | 77.2 | 100 | 4.75 |
| + | Triadimenol (30) | 21 | 25.9 | 69.2 | 60 | 74.4 | 96.4 | 4.50 |
| + | Metalaxyl (2) | 37 | 46.6 | 124.2 | 73 | 90.9 | 117.8 | 3.75 |
| + | Metalaxyl (7.5) | 34 | 42.8 | 114.2 | 73 | 91.6 | 118.6 | 3.5 |
| + | Metalaxyl (1), | 35 | 43.4 | 115.8 | 74 | 92.8 | 120.2 | 3.75 |
| | Saponin (0.6) | | | | | | | |

GA: grams of active ingredient;
Kg: kilograms;
DAA: days after application of composition to seed

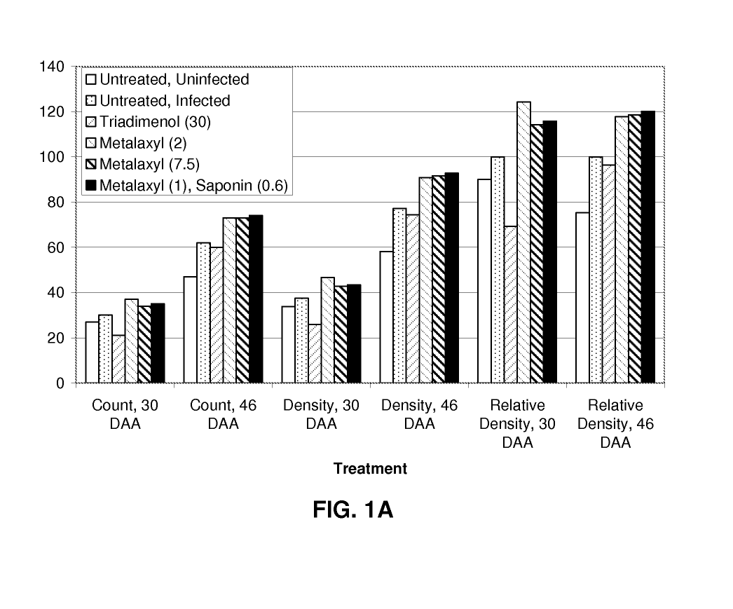

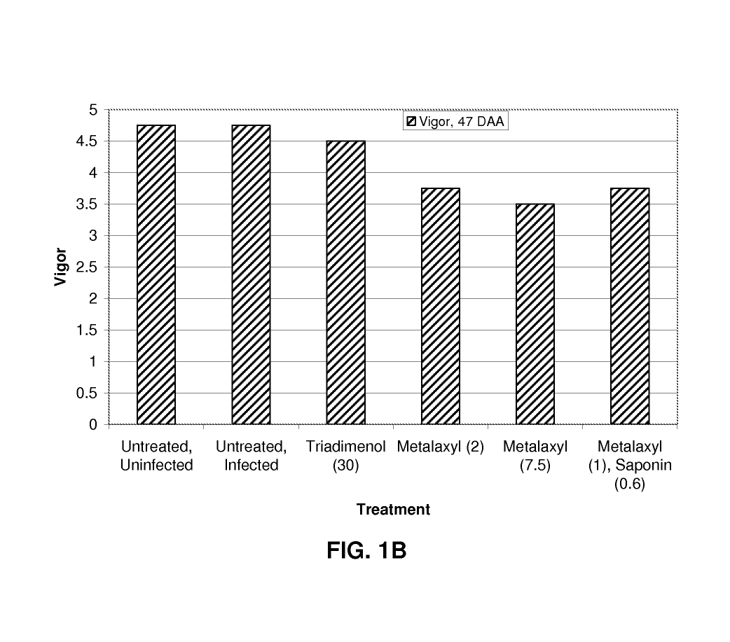

The data of TABLE 1 are shown graphically in FIGS. 1A and 1B. As shown by TABLE 1 and FIGS. 1A and 1B, the count and the density increased—over time—for all treatment conditions. The relative density, however, decreased over time for the untreated/uninfected and metalaxyl (2 GA/100 kg) categories. The relative density remained the same for the untreated/uninfected category because it provided the reference point (i.e., the relative densities were calculated with reference to the untreated/uninfected category). Interestingly, the application of 1 GA/100 Kg of metalaxyl (one-half the industry standard dose of metalaxyl, for corn) in concert with 0.6 GA/100 Kg of saponin yielded counts, densities, and relative densities comparable to those achieved with 2 GA/100 Kg metalaxyl alone or with 7.5 GA/100 Kg metalaxyl alone. As shown by FIG. 1B, the vigor of plants treated with 1 GA/100 Kg of metalaxyl and 0.6 GA/100 Kg of saponin was comparable to that of plants treated with 2 GA/100 Kg metalaxyl alone or with 7.5 GA/100 Kg metalaxyl alone.

### Example 2

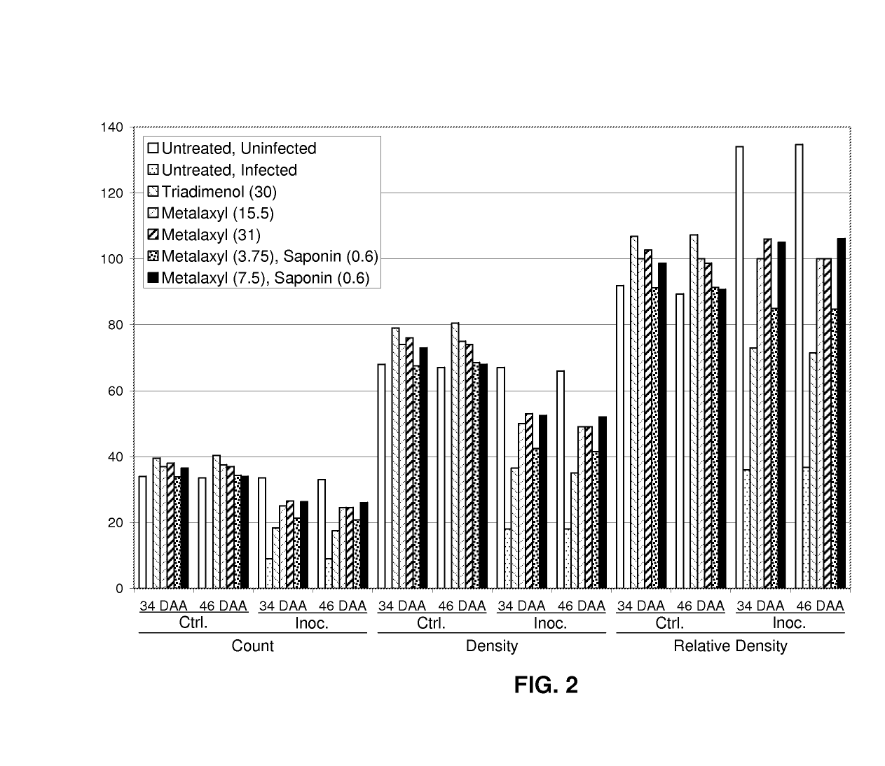

Example 2 shows the advantages achieved by applying the combination of at least one saponin with at least one fungicide to cotton. As shown in TABLE 2, cotton seeds infected with Pythium were exposed to various treatment regimens. The seeds were planted in a field, either in soil that had been inoculated with Pythium (Soil Inoc. with Pythium), or in soil that had not been inoculated with Pythium (Ctrl.), then allowed to grow. Concentrations and compositions of triadimenol, metalaxyl, and saponin are the same as given in Example 1. For cotton, the industry standard dosage of metalaxyl is 15.5 grams of active ingredient per 100 kilograms of seed (15.5 GA/100 Kg). Unexpectedly, and as shown in TABLE 2, the combination of saponin with half of the industry-standard dosage of metalaxyl yielded results comparable to those seen with metalaxyl alone at either the industry-standard dosage or at twice the industry-standard dosage (see TABLE 1). The data of TABLE 2 are shown graphically in FIG. 2. The relative densities for the data of TABLE 2 and FIG. 2 were calculated with reference to the 15.5 GA/100 Kg metalaxyl category. As shown by TABLE 2 and FIG. 2, inoculation of the soil with Pythium was correlated with a general decrease in cotton seedling count and density (compare Ctrl. versus Inoc.). When challenged with Pythium inoculum, seeds pre-treated with 3.75 GA/100 Kg of metalaxyl and 0.6 GA/100 Kg of saponin performed almost as well as seeds pre-treated with 15.5 GA/100 Kg metalaxyl alone (the industry standard dose for cotton), and seeds pre-treated with 7.5 GA/100 Kg of metalaxyl and 0.6 GA/100 Kg of saponin performed as well as or better than seeds pre-treated with 15.5 GA/100 Kg metalaxyl alone or seeds pre-treated with 31 GA/100 Kg metalaxyl alone (twice the industry standard dose for cotton).

### Example 3

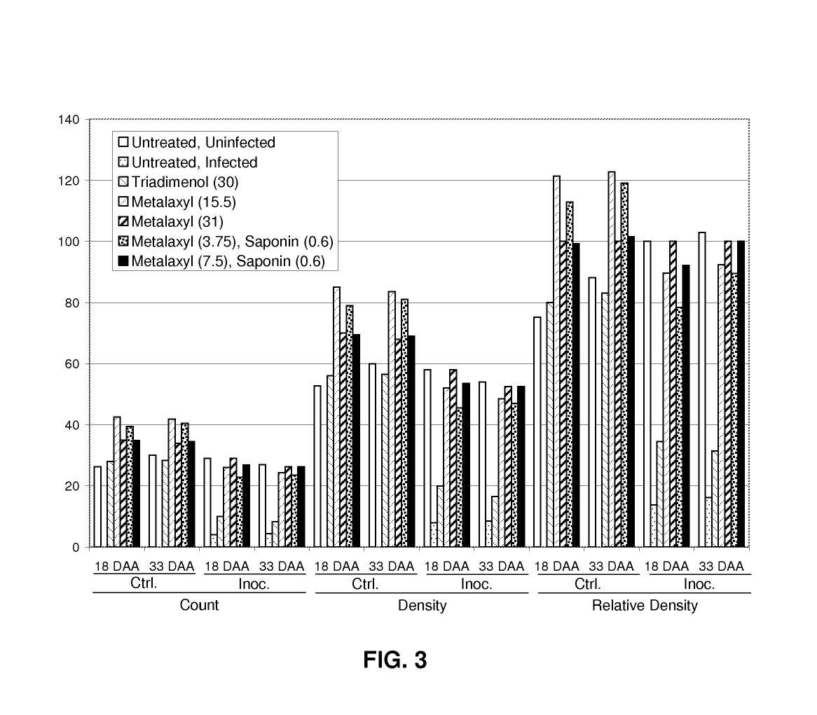

Example 3 shows the surprising advantages achieved by applying the combination of at least one saponin with at least one fungicide to cucumber. As shown in TABLE 3, cucumber seeds infected with Pythium were exposed to various treatment regimens. The seeds were planted in a field, either in soil that had been inoculated with Pythium (Soil Inoc. with Pythium), or in soil that had not been inoculated with Pythium (Ctrl.), then allowed to grow. Concentrations and compositions of triadimenol, metalaxyl, and saponin are the same as given in Example 1. For cucumber, the industry standard dosage of metalaxyl is 15.5 grams of active ingredient per 100 kilograms of seed (15.5 GA/100 Kg). Unexpectedly, and as shown in TABLE 3, the combination of saponin with half of the industry-standard dosage of Allegiance yielded results comparable to those seen with metalaxyl alone either the industry-standard dosage or at twice the industry-standard dosage (see TABLE 1). The data of TABLE 3 are shown graphically in FIG. 3. The relative densities for the data of TABLE 3 and FIG. 3 were calculated with reference to the 31 GA/100 Kg metalaxyl category. As shown by TABLE 3 and FIG. 3, inoculation of the soil with Pythium was correlated with a general decrease in cucumber seedling count, density, and relative density (compare Ctrl. versus Inoc.). When challenged with Pythium inoculum, cucumber seeds pre-treated with 3.75 GA/100 Kg of metalaxyl and 0.6 GA/100 Kg of saponin did not perform as well as seeds pre-treated with 15.5 GA/100 Kg metalaxyl alone (the industry standard dose for cucumber), but seeds pre-treated with 7.5 GA/100 Kg of metalaxyl and 0.6 GA/100 Kg of saponin performed as well as or better than seeds pre-treated with 15.5 GA/100 Kg metalaxyl alone or seeds pre-treated with 31 GA/100 Kg metalaxyl alone (twice the industry standard dose for cucumber).

TABLE 2
Cotton

| | | 34 DAA | | | | | | 46 DAA | | | | | |
|---|---|---|---|---|---|---|---|---|---|---|---|---|---|
| | | Ctrl. | | | Soil Inoc. with Pythium | | | Ctrl. | | | Soil Inoc. with Pythium | | |
| Pythium | Treatment | | | Relative | | | Relative | | | Relative | | | Relative |
| (+/−) | (GA/100 Kg) | Count | Density | Density | Count | Density | Density | Count | Density | Density | Count | Density | Density |
| − | — | 34 | 68 | 91.9 | 33.5 | 67 | 134 | 33.5 | 67 | 89.3 | 33 | 66 | 134.7 |
| + | — | — | — | — | 9 | 18 | 36 | — | — | — | 9 | 18 | 36.7 |
| + | Triadimenol | 39.5 | 79 | 106.8 | 18.3 | 36.5 | 73 | 40.3 | 80.5 | 107.3 | 17.5 | 35 | 71.4 |
| | (30) | | | | | | | | | | | | |
| + | Metalaxyl | 37 | 74 | 100 | 25 | 50 | 100 | 37.5 | 75 | 100 | 24.5 | 49 | 100 |
| | (15.5) | | | | | | | | | | | | |
| + | Metalaxyl | 38 | 76 | 102.7 | 26.5 | 53 | 106 | 37 | 74 | 98.7 | 24.5 | 49 | 100 |
| | (31) | | | | | | | | | | | | |
| + | Metalaxyl | 33.8 | 67.5 | 91.2 | 21.3 | 42.5 | 85 | 34.3 | 68.5 | 91.3 | 20.8 | 41.5 | 84.7 |
| | (3.75) | | | | | | | | | | | | |
| | Saponin | | | | | | | | | | | | |
| | (0.6) | | | | | | | | | | | | |
| + | Metalaxyl | 36.5 | 73 | 98.6 | 26.3 | 52.5 | 105 | 34 | 68 | 90.7 | 26 | 52 | 106.1 |
| | (7.5) | | | | | | | | | | | | |
| | Saponin | | | | | | | | | | | | |
| | (0.6) | | | | | | | | | | | | |

GA: grams of active ingredient;
Kg: kilograms;
DAA: days after application of composition to seed

TABLE 3
Cucumber

| | | 18 DAA | | | | | | 33 DAA | | | | | |
|---|---|---|---|---|---|---|---|---|---|---|---|---|---|
| | | Ctrl. | | | Soil Inoc. with Pythium | | | Ctrl. | | | Soil Inoc. with Pythium | | |
| Pythium | Treatment | | | Relative | | | Relative | | | Relative | | | Relative |
| (+/−) | (GA/100 Kg) | Count | Density | Density | Count | Density | Density | Count | Density | Density | Count | Density | Density |
| − | — | 26.3 | 52.7 | 75.2 | 29 | 58 | 100 | 30 | 60 | 88.2 | 27 | 54 | 102.9 |
| + | — | — | — | — | 4 | 8 | 13.8 | — | — | — | | | |
| + | Triadimenol | 28 | 56 | 80 | 10 | 20 | 34.5 | 28.3 | 56.5 | 83.1 | 4.3 | 8.5 | 16.2 |
| | (30) | | | | | | | | | | | | |
| + | Metalaxyl | 42.5 | 85 | 121.4 | 26 | 52 | 89.7 | 41.8 | 83.5 | 122.8 | | | |
| | (15.5) | | | | | | | | | | | | |
| + | Metalaxyl | 35 | 70 | 100 | 29 | 58 | 100 | 34 | 68 | 100 | 8.3 | 16.5 | 31.4 |
| | (31) | | | | | | | | | | | | |
| + | Metalaxyl | 39.5 | 79 | 112.9 | 22.8 | 45.5 | 78.4 | 40.5 | 81 | 119.1 | 24.3 | 48.5 | 92.4 |
| | (3.75) | | | | | | | | | | | | |
| | Saponin | | | | | | | | | | | | |
| | (0.6) | | | | | | | | | | | | |
| + | Metalaxyl | 34.8 | 69.5 | 99.3 | 26.8 | 53.5 | 92.2 | 34.5 | 69 | 101.5 | 26.3 | 52.5 | 100 |
| | (7.5) | | | | | | | | | | | | |
| | Saponin | | | | | | | | | | | | |
| | (0.6) | | | | | | | | | | | | |

GA: grams of active ingredient;
Kg: kilograms;
DAA: days after application of composition to seed

### Example 4

Example 4 shows the surprising advantages achieved by applying the combination of at least one saponin with at least one fungicide to different corn hybrids. As shown in TABLE 4, corn seeds of two different hybrids (Hybrid A, and Hybrid B) infected with Pythium were exposed to various treatment regimens, and then allowed to grow in a greenhouse to determine whether the effects observed in the field could be reproduced in a greenhouse setting. Concentrations and compositions of triadimenol, metalaxyl, and saponin are the same as given in Example 1.

TABLE 4
Corn

| | | Count, Hybrid A | | | Count, Hybrid B | | |
|---|---|---|---|---|---|---|---|
| Pythium | Treatment | Day | | Day | Day | Day | Day |
| (+/−) | (GA/100 Kg) | 2 | Day 7 | 14 | 2 | 7 | 14 |
| − | — | 90 | 94 | 94 | 84 | 88 | 88 |
| + | — | 20 | 24 | 24 | 2 | 6 | 6 |
| + | Triadimenol (30) | 62 | 72 | 74 | 24 | 40 | 40 |
| + | Metalaxyl (2) | 92 | 98 | 98 | 74 | 88 | 88 |
| + | Metalaxyl (7.5) | 94 | 96 | 96 | 64 | 94 | 98 |
| + | Metalaxyl (1) | 94 | 98 | 98 | 74 | 82 | 82 |
| | Saponin (0.6) | | | | | | |

GA: grams of active ingredient;
Kg: kilograms

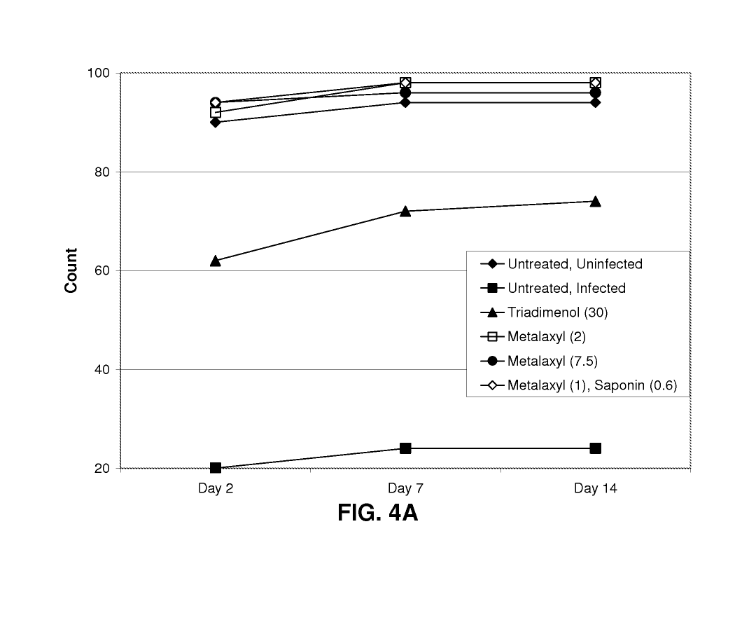

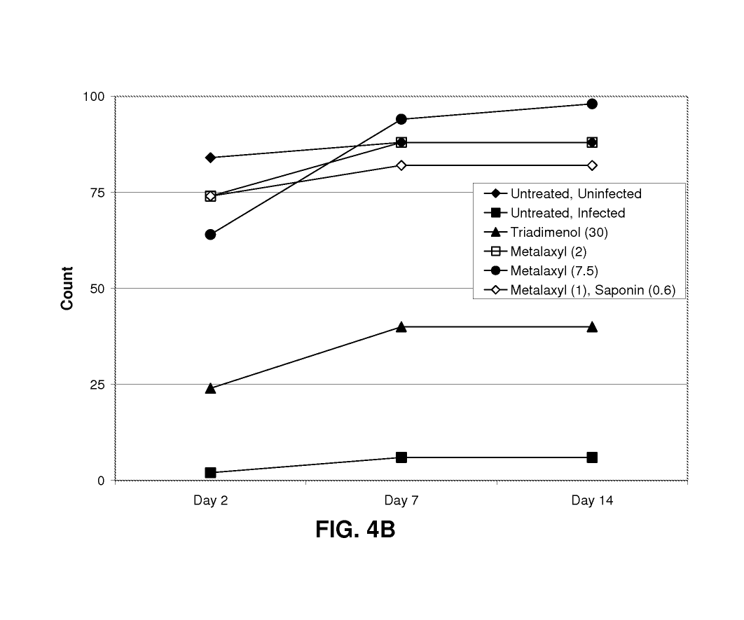

The data of TABLE 4 are shown graphically in FIGS. 4A and 4B. As shown by TABLE 4 and FIGS. 4A and 4B, pre-treatment of both varieties of corn seeds with 1 GA/100 Kg metalaxyl and 0.6 GA/100 Kg yielded counts similar to those achieved from pre-treatment of seeds with either 2 GA/100 Kg metalaxyl (the industry standard dose for corn) or 7.5 GA/100 Kg metalaxyl.

### Example 5

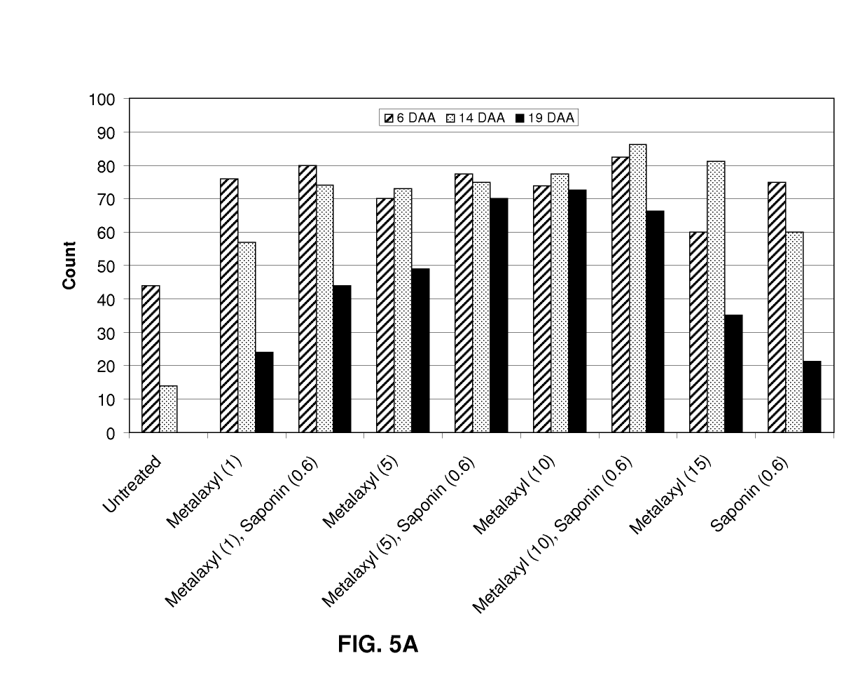

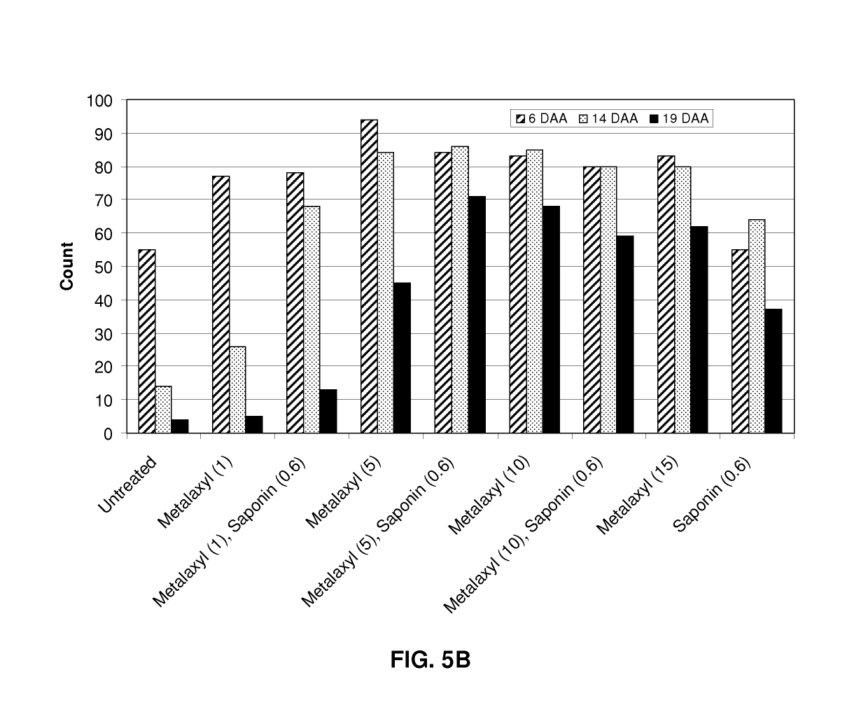

Example 5 shows the suppression of fungal resistance to fungicide when at least one fungicide is supplied together with at least one saponin. Two different varieties of cotton seedlings (Variety A, and Variety B) that were infected with Pythium ultimum were exposed to various rates of metalaxyl, saponins, or metalaxyl+Saponin, and then allowed to grow in a greenhouse to determine whether the effects observed in the field could be reproduced in a greenhouse setting. This particular strain of Pythium ultimum was shown previously to have a mid-degree of resistance to seed treatments containing metalaxyl and/or L-metalaxyl. As shown in TABLE 5, the addition of saponin to metalaxyl enhanced plant stand counts at levels of metalaxyl that were significantly lower than the commercial standard rate of 15 GA/100 Kg. Data from Variety A, the weakest seed source based on stand count of the untreated seed, showed that addition of saponin to metalaxyl at 1 and 5 GA/100 Kg resulted in stand counts at days 14 and 19 that were equivalent to or better than the counts achieved with the commercial standard rate of metalaxyl (see FIG. 5A). The stand counts from Variety B show a similar trend with the 1 GA/100 Kg rate of metalaxyl (see FIG. 5B). The additional strength of the inherent genetics of Variety B did not allow for separation of the metalaxyl rates with or without Saponin as with Variety A.

TABLE 5
Cotton

| | | Count, Variety A | | | Count, Variety B | | |
|---|---|---|---|---|---|---|---|
| Pythium | Treatment | | Day | | Day | Day | Day |
| (+/−) | (GA/100 Kg) | Day 6 | 14 | Day 19 | 6 | 14 | 19 |
| + | — | 44 | 14 | 0 | 55 | 14 | 4 |
| + | Metalaxyl (1) | 76 | 57 | 24 | 77 | 26 | 5 |
| + | Metalaxyl (1) | 80 | 74 | 44 | 78 | 68 | 13 |
| | Saponin (0.6) | | | | | | |
| + | Metalaxyl (5) | 70 | 73 | 49 | 94 | 84 | 45 |
| + | Metalaxyl (5) | 77.5 | 75 | 70 | 84 | 86 | 71 |
| | Saponin (0.6) | | | | | | |
| + | Metalaxyl (10) | 73.75 | 77.5 | 72.5 | 83 | 85 | 68 |
| + | Metalaxyl (10) | 82.5 | 86.25 | 66.25 | 80 | 80 | 59 |
| | Saponin (0.6) | | | | | | |
| + | Metalaxyl (15) | 60 | 81.25 | 36.25 | 83 | 80 | 62 |
| + | Saponin (0.6) | 75 | 60 | 21.25 | 55 | 64 | 37 |

All references cited in this specification are herein incorporated by reference as though each reference was specifically and individually indicated to be incorporated by reference.

It will be understood that each of the elements described above, or two or more together may also find a useful application in other types of methods differing from the type described above. Without further analysis, the foregoing will so fully reveal the gist of the present compositions and methods that others can, by applying current knowledge, readily adapt it for various applications without omitting features that, from the standpoint of prior art, fairly constitute essential characteristics of the generic or specific aspects of these compositions and methods set forth in the appended claims. The foregoing embodiments are presented by way of example only; the scope of the present compositions and methods are to be limited only by the following claims.

We claim:

1. A composition comprising at least one fungicide and at least one compound that produces systemic acquired resistance to a pathogen in a seed and/or a plant.

2. The composition of claim 1, wherein said at least one fungicide is a xylylalanine.

3. The composition of claim 2, wherein said xylylalanine is selected from the group consisting of benalaxyl, furalaxyl, mefenoxam, metalaxyl, L-metalaxyl, and combinations thereof.

4. The composition of claim 1, wherein said at least one compound that produces systemic acquired resistance is at least one saponin.

5. The composition of claim 4, wherein said at least one saponin is obtained from Chenopodium quinoa.

6. The composition of claim 4, wherein said at least one saponin is approximately equimolar amounts of the triterpene bidesmosidic glycosides of oleanolic acid, hederagenin, and phytolaccagenic acid.

7. The composition of claim 6, wherein said fungicide is metalaxyl.

8. The composition of claim 1, further comprising an insecticide.

9. The composition of claim 1, further comprising at least one species of bacterium.

10. The composition of claim 1, further comprising a nematicide.

11. A method of protecting a seed or plant from disease, the method comprising applying a composition comprising at least one fungicide and at least one compound that produces systemic acquired resistance to said seed or plant.

12. The method of claim 11, wherein said at least one fungicide is a xylylalanine.

13. The method of claim 12, wherein said xylylalanine is selected from the group consisting of benalaxyl, furalaxyl, mefenoxam, metalaxyl, L-metalaxyl, and combinations thereof.

14. The method of claim 11, wherein said at least one compound that produces systemic acquired resistance is at least one saponin.

15. The method of claim 14, wherein said at least one saponin is obtained from Chenopodium quinoa.

16. The method of claim 14, wherein said at least one saponin is approximately equimolar amounts of the triterpene bidesmosidic glycosides of oleanolic acid, hederagenin, and phytolaccagenic acid.

17. The method of claim 16, wherein said fungicide is metalaxyl.

18. The method of claim 12, wherein the composition further comprises at least one insecticide.

19. The method of claim 12, wherein the composition further comprises at least one species of bacterium.

20. The method of claim 12, wherein the composition further comprises at least one nematicide.

21. A seed having an outer surface and composition comprising at least one fungicide and at least one compound that produces systemic acquired resistance.

22. The seed of claim 21, wherein said at least one fungicide is a xylylalanine.

23. The seed of claim 22, wherein said xylylalanine is selected from the group consisting of benalaxyl, furalaxyl, mefenoxam, metalaxyl, L-metalaxyl, and combinations thereof.

24. The seed of claim 21, wherein said at least one compound that produces systemic acquired resistance is at least one saponin.

25. The seed of claim 24, wherein said at least one saponin is obtained from Chenopodium quinoa.

26. The seed of claim 26, wherein said at least one saponin is approximately equimolar amounts of the triterpene bidesmosidic glycosides of oleanolic acid, hederagenin, and phytolaccagenic acid.

27. The seed of claim 26, wherein said fungicide is metalaxyl.

28. The seed of claim 22, wherein said outer surface and composition further comprises an insecticide.

29. The seed of claim 22, wherein said outer surface and composition further comprises at least one species of bacterium.

30. The seed of claim 22, wherein said outer surface and composition further comprises a nematicide.

31. A method of reducing or preventing the spread of fungicide resistance in fungi, the method comprising the step of applying to a seed or a plant a composition comprising at least one fungicide and at least one compound that produces systemic acquired resistance.
